(19) United States
(12) Patent Application Publication
(10) Pub. No.: US 2006/0130129 A1
(43) Pub. Date: Jun. 15, 2006

(54) Authentication method based on private space of the usb flash memory media

(76) Inventors: Huafeng Dai, Beijing (CN); Yimin Zheng, Beijing (CN)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/559,876

(22) PCT Filed: Jun. 11, 2004
(86) PCT No.: PCT/CN04/00630

§ 371 Date: Dec. 7, 2005

(30) Foreign Application Priority Data
Jun. 13, 2003 (CN) 03137109.4

(51) Int. Cl. H04L 9/32

(52) U.S. Cl. 726/9; 713/185

(57) ABSTRACT

The present invention discloses an authentication method based on private bytes of USB flash memory media, and implements a unit for executing authentication by using private bytes of USB flash memory media which is often used. A control chip of the USB flash memory disk receives a read/write instruction sent from the authentication unit, determines whether a read/write operation is executed to the private bytes. If it is, the read/write operation to the private bytes is executed. Otherwise, the read/write operation to normal bytes is executed. Thus, a variety of authentication information can be stored in the private bytes of the USB flash memory disk, which are invisible to users and can not be copied and deleted. The normal data can be stored in the normal bytes of the USB flash memory disk so that an encryption and authentication mechanism can be achieved with security and convenience.

### BACKGROUND OF THE INVENTION

1. Field of Invention

The present invention relates to an authentication method based on private bytes of USB flash memory media, and uses for the field of computer security.

2. Description of Prior Art

Conventional computers generally have no encryption devices. Recently, the privacy of the personal computers is paid more and more attention, especially for the security of business secretes and personal materials. Generally, the encryption function of the conventional computes is implemented by software. However, the probability that software is hacked is increased, and thus the information in the computers is less secure. On the other hand, most of the encryption methods with hardware, which are commercial available, are the use of Smart Cards, fingerprint recognition and watchdog which is a hardware encryption device. Although the encryption methods with hardware generates better effects than the use of the software, some disadvantages in those methods are as follows:

1. The use of the encryption methods with hardware lacks popularity and the use is limited, for example, a lot of computers can not support a Smart Card;

2. The hardware structure and circuit is complex, which results in an expensive cost; and

3. The function of such encryption by using hardware is alone and thus does not represent notable advantages to the users.

Recently, products encrypted with Universal Serial Bus (USB) flash memory disks also appear. But the encrypted information is placed in normal bytes of the USB flash memory disks, which is visible to the ordinary users and can be copied and deleted. Therefore, the security of the encryption can not be guaranteed well.

### SUMMARY OF THE INVENTION

The object of the present invention is to provide an authentication method based on private bytes of USB flash memory media which uses a commonly used USB flash memory media, for example, USB flash memory disk, with combination with authentication software. The method of the present invention uses the private bytes of the USB flash memory disk, which are invisible to a normal user and can not be copied and deleted, to store encrypted information and encrypted files so that the computer encryption and authentication can be achieved with security and convenience.

The object of the present invention is achieved by the following technical solutions.

An authentication method based on private bytes of USB flash memory media, comprising:

step 10, reading authentication information from the private bytes of the USB flash memory media by an authentication unit;

step 20, authenticating, by the authentication unit, the authentication information input by a user by using the authentication information read from the private bytes of the USB flash memory media;

step 30, determining whether the authentication is successful or not, if it is successful, opening an operation authorization based on the authentication information, otherwise, executing a process for failed authentication.

Preferably, before the step 10, the method further comprises:

step 1, detecting whether the USB flash memory disk is connected to the authentication unit, if it is, executing the step 10;

step 2, inquiring the user whether to re-authenticate or not, if the user determines to re-authenticate, then prompting the user to connect a USB flash memory media to a USB interface, and executing the step 1 after confirming the connection, otherwise, determining that the authentication is failed, and executing the process for failed authentication.

Further, the process for failed authentication in the step 30 is to execute the step 2.

Alternatively, before the step 10, the method further comprises:

step 1′, detecting, by the authentication unit, whether the USB flash memory disk is connected to the authentication unit or not;

step 2′, if the connection is held, executing the step 1′ after a predetermined time period, and if the connection is not held, then locking the operating system (for example, windows);

step 3′, prompting the user to connect the USB flash memory media to the USB interface and inputting the authentication information;

step 4′, detecting, by the authentication unit, whether the USB flash memory media is connected to the authentication unit;

step 5′, if the connection is held, then executing the step 10; otherwise, executing the step 3′.

The process for failed authentication in the step 30 is to release the lock of the operating system and execute the step 1′ if it is successful, otherwise, execute the step 4′.

Preferably, the authentication method based on private bytes of USB flash memory media further comprises the step of setting the authentication information to the private bytes of the USB flash memory media when the authentication unit is installed, the setting step comprising:

step A, sending the authentication information input by the user to the private bytes of the USB flash memory media by the authentication unit; step B, determining whether the operation of writing the authentication information into the private bytes of the USB flash memory media is successful, if it is successful, opening an operation authorization based on the authentication information, otherwise, executing a subsequent process for failed authentication if the operation of writing the authentication information is not successful.

Preferably, the operating system log-on information of the user is contained in the authentication information.

Preferably, before the step A, the method further comprises:

step X, detecting, by the authentication unit, whether the USB flash memory media is connected to the authentication unit, if the connection is held, executing the step A;

step Y, inquiring the user whether to re-authenticate or not , if the user determines to re-authenticate, then prompting the user to connect the USB flash memory disk to the USB interface, and executing the step X after confirming the connection; otherwise, determining that the authentication is failed, and ending the setting process.

The subsequent process for failed authentication in the step B is to execute the step Y.

A control chip of the USB flash memory media receives a read/write instruction sent from the authentication unit, determines whether a read/write operation is executed to the private bytes, if it is, the read/write operation to the private bytes is executed, if it is not, the read/write operation to normal bytes is executed.

The present invention implements a module for executing authentication by using private bytes of USB flash memory media which is often used. A control chip of the USB flash memory media receives a read/write instruction sent from the authentication unit, determines whether a read/write operation is executed to the private bytes. If it is, the read/write operation to the private bytes is executed. If it is not, the read/write operation to normal bytes is executed. Thus, a variety of authentication information can be stored in the private bytes, which are invisible to a normal user and can not be copied and deleted, of the USB flash memory media, for example, a USB flash memory disk. The normal data can be stored in the normal bytes of the USB flash memory disk. According to the present invention, an encryption and authentication mechanism is achieved with security and convenience.

### BRIEF DESCRIPTION OF THE DRAWINGS

The above and other objects, features and advantages of the present invention will be clearer from the following detailed description about the non-limited embodiments of the present invention taken in conjunction with the accompanied drawings, in which:

FIG. 1 is a block diagram showing the security authentication mechanism combining the security software and the USB flash memory disk according to an embodiment of the present invention;

FIG. 2 is a diagram showing the function relationships while executing read/write operation by using the USB flash memory disk according to the embodiment of the present invention;

FIG. 3 is a flowchart showing the process for writing a USB flash memory disk password while the security software is installed according to the embodiment of the present invention;

FIG. 4 is a flowchart showing the process for authentication while the operation system of a computer is started-up according to the embodiment of the present invention;

FIG. 5 is a flowchart showing the process for monitoring the USB flash memory disk and executing authentication after the USB flash memory disk is disconnected with the USB interface according to the embodiment of the present invention;

FIG. 6 is a flowchart showing the process for encrypting files by using the method of the present invention; and

FIG. 7 is a flowchart showing the process for decrypting files by using the method of the present invention.

### DETAILED DESCRIPTION OF PREFERRED EMBODIMENTS

The present invention will be described in conjunction with the embodiments and with reference to the drawings in detailed as below.

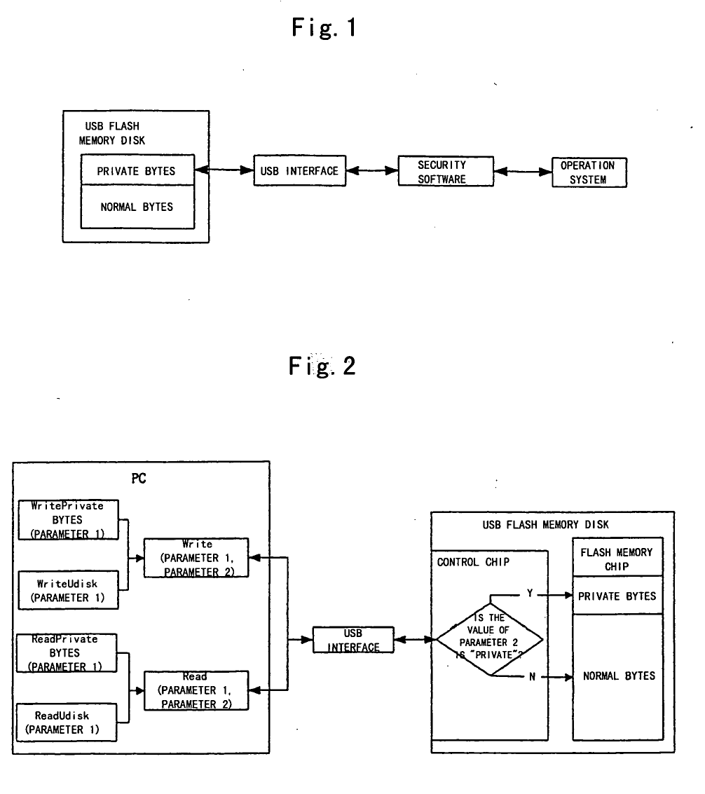

As shown in FIG. 1, the method according to an embodiment of the present invention installs security software into an operation system run on a computer. Information is exchanged between the security software and a USB flash memory disk via a USB interface.

As shown in FIG. 2, the information is exchanged between the computer and the USB flash memory disk by using functions. The computer reads/writes file information from/into the normal bytes of the USB flash memory disk by invoking a function of ReadUdisk (parameter 1)/WriteUdisk (parameter 1). The file information is read/written from/into private bytes of the USB flash memory disk by invoking a function of ReadPrivateBYTES (parameter 1)/WritePrivateBYTES (parameter 1). The above two sets of functions are finally converted into a set of read/write functions of Read (parameter 1, parameter 2)/Write (parameter 1, parameter 2) so that the bottom layer read/write operation is executed. For the parameters, the parameter 1 is the contents to be read/written, and the parameter 2 is a flag for indicating the normal/private bytes. A control chip of the USB judges the parameter 2 of the read/write functions. If the parameter 2 indicates “private”, then the control chip will read from the private bytes of the USB flash memory chip. If the parameter 2 does not indicate “private”, then the control chip will read from the normal bytes thereof.

The Difference between the Private Bytes and the Normal Bytes is as follows.

The private bytes are also referred as reserved bytes and are generally set during the manufacturing and the contents to be stored therein can be written by dedicated tools. The users can not change the properties, sizes and contents of the private bytes. In addition, these private bytes are invisible to the users and can not be formatted.

The normal bytes are storage areas which can be used by the users with a right of complete control.

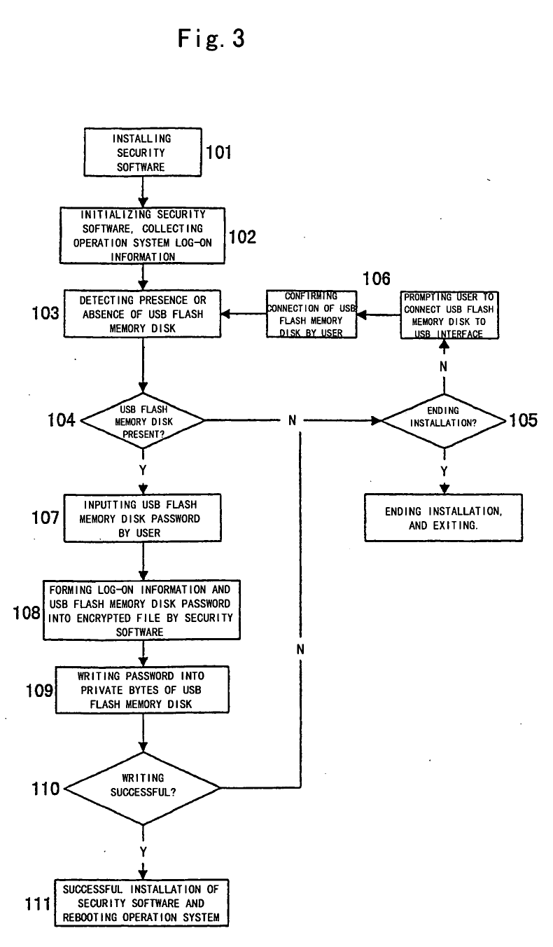

Next, the process of writing a USB flash memory disk password and installing the security software will be described with reference to FIG. 3, which shows a flowchart for writing a USB flash memory disk password while the security software is installed according to an embodiment of the present invention. As shown in FIG. 3, when the security software is installed, a password and other authentication information set by the user are written into the USB flash memory media, for example, a USB flash memory disk. The process includes the steps as follows.

At step 101, the security software is installed.

At step 102, the security software is initialized, and the operation system log-on information such as username and log-on password is collected.

At step 103, whether the USB flash memory disk is properly connected or not is detected;

At step 104, whether the USB flash memory disk is properly connected is determining based on the detecting result of the step 103. If so, the process goes to step 107.

At step 105, the user is inquired whether to end the installation or not. If the user confirms the complete of the software installation, then the security software is quitted, and the installation procedure is ended. Therefore, the installation of the software is fail.

At step 106, the user is prompted to connect the USB flash memory disk to the USB interface, and the process goes to the step 103 after the user confirms the connection.

At step 107, a password of the USB flash memory disk is inputted by the user.

At step 108, the operation system log-on information and the USB flash memory disk password is formed into an encrypted file.

At step 109, the password is written into the private bytes or the normal bytes of the USB flash memory disk.

At step 110, it judges whether the writing of the password is successful or not. If it is, the process goes to execute the step 111. If it is not, the process returns to the step 105.

At step 111, the installation of the security software is complete, the operation system is rebooted.

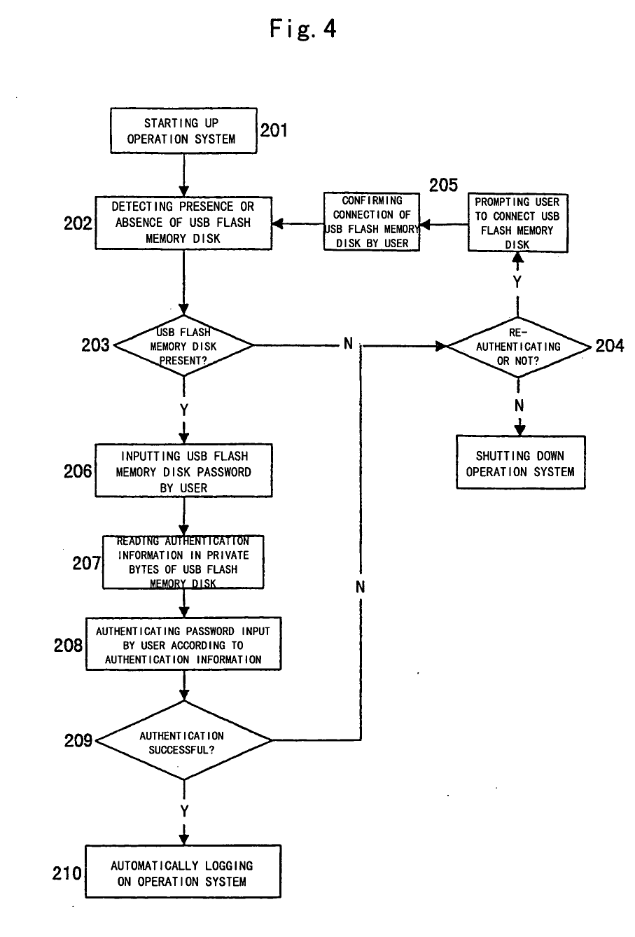

Next, the flow for authentication while the operation system of a computer is started-up will be described with reference of FIG. 4. As shown in FIG. 4, whenever the operating system starts up, the security software installed in the computer executes a security authentication to the user before the user logs-on the computer. If the authentication is passed, an automatic log-on is then executed based on the operation system log-on information stored in the USB flash memory disk. Otherwise, the operation system will be shut down. The steps for the authentication are as follows.

At step 201, the operation system is started up.

At step 202, whether the USB flash memory disk is properly connected or not is detected.

At step 203, whether the USB flash memory disk is properly connected or not is determined based on the detecting result in the step 202. If it is, the process goes to the step 206. If it is not, the process proceeds to the step 204;

At step 204, the user is inquired whether to re-authenticate or not. If the user determines to re-authenticate, the process goes to the step 205. Otherwise, the operation system is shut down.

At step 205, the user is prompted to connect the USB flash memory disk to the USB interface, and the process returns to the step 202 after the user confirms the connection;

At step 206, the user inputs a USB flash memory disk password;

At step 207, the authentication information of the USB flash memory disk is read.

At step 208, the password input by the user is authenticated according to the authentication information.

At step 209, whether the authentication is successful or not is determined. If it is successful, the process goes to the step 210, and if it is not, the process returns to the step 204.

At step 210, the operation system is automatically logged on with the operation system log-on information stored in the USB flash memory disk.

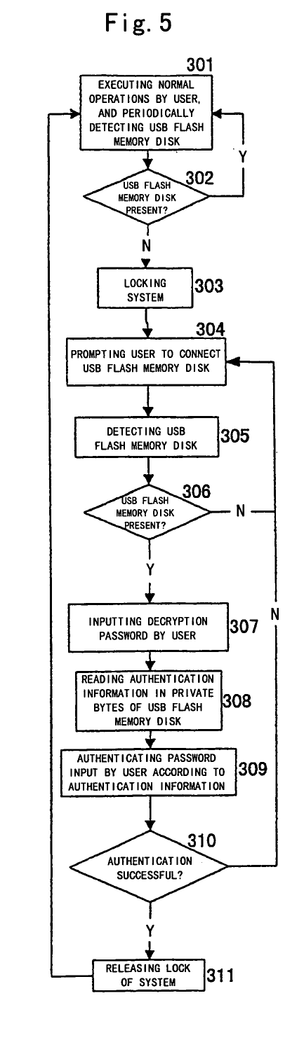

Next, the process for monitoring the USB flash memory disk and executing authentication after the USB flash memory disk disconnects with the USB interface will be described with reference to FIG. 5. As shown in FIG. 5, the security software will periodically detect the status of the USB flash memory disk during the operating system normally operates. In a case where the user temporarily leaves the computer, it is not necessary to shut down the operation system, only the pullout of the USB flash memory disk is enough. The system will be locked automatically when the security software detects the absence of the USB flash memory disk. Only if the USB flash memory disk is connected to the computer (USB interface) and the security authentication is passed, the security software releases the lock of the system and causes the system resuming the normal operation conditions. The steps for monitoring and executing authentication are as follows.

At step 301, the security software periodically detects the USB flash memory disk when the user executes normal operations;

At step 302, it determines whether the USB flash memory disk is properly connected or not based on the detecting result in the step 301. If it is, the process returns to the step 301. Otherwise, the process goes to the step 303.

At step 303, the operating system is locked.

At step 304, the user is prompted to connect the USB flash memory disk to the USB interface.

At step 305, whether the USB flash memory disk is properly connected or not is detected after the connecting of the USB flash memory disk.

At step 306, whether the USB flash memory disk is properly connected or not is determined based on the detecting result in step 305. If it is, the process goes to the step 307. Otherwise, process returns to the step 304.

At step 307, the user inputs a USB flash memory disk password.

At step 308, the authentication information of the USB flash memory disk is read.

At step 309, the password input by the user is authenticated according to the authentication information;

At step 310, whether the authentication is successful or not is determined. If it is successful, the process goes to the step 311. If it is not, the process returns to the step 304.

At step 311, the lock of the operating system is released and then the process returns to the step 301.

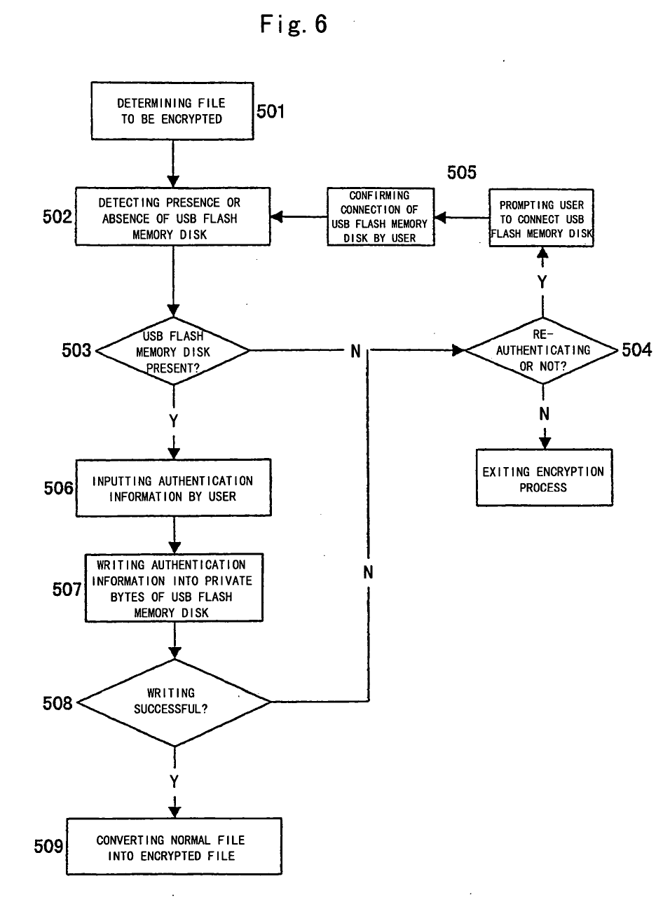

The encryption/decryption to files with the security software and the USB flash memory disk will be described with reference to FIG. 6. As shown in FIG. 6, the method of the present invention can be further used to encrypt/decrypt files. The process of encrypting files with the security software and the USB flash memory disk includes the following steps.

At step 501, the file to be encrypted is determined.

At step 502, whether the USB flash memory disk is properly connected or not is detected;

At step 503, whether the USB flash memory disk is properly connected or not is determined based on the detecting result in the step 502. If it is, the process goes to the step 506. If it is not, the process goes to the step 504.

At step 504, the user is inquired whether to re-authenticate or not. If the user determines to re-authenticate, the process goes to the step 505. Otherwise,the encryption process is exited, and the file is unencrypted.

At step 505, the user is prompted to connect a USB flash memory disk to the USB interface. The process goes to the step 502 after confirming the connecting of the USB flash memory disk.

At step 506, the user inputs an encryption password.

At step 507, the authentication information is written into the private bytes of the USB flash memory disk.

At step 508, it judges whether the writing of the authentication information is successful or not. If it is successful, the process goes to the step 509. Otherwise, the process returns to the step 504;

At step 509, the normal file is converted into an encrypted file.

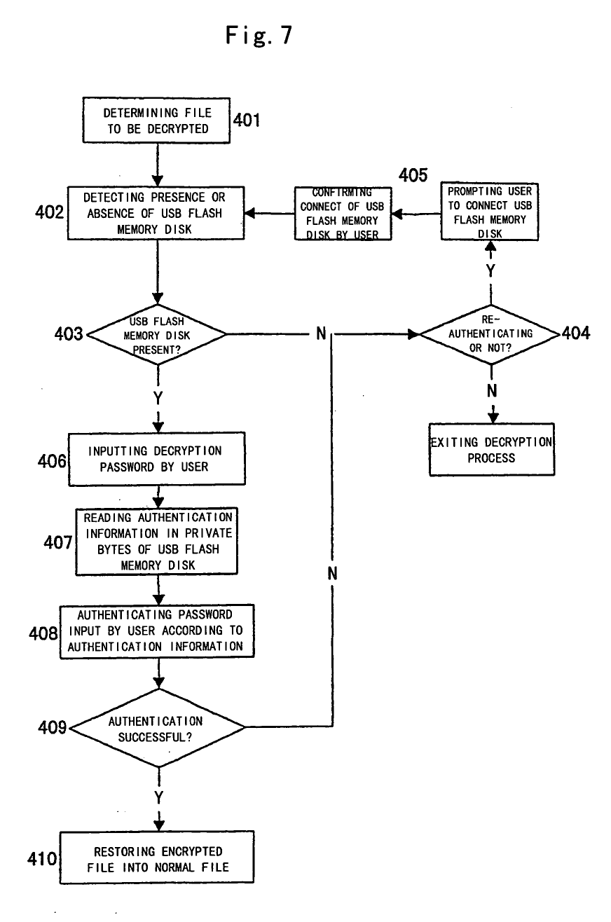

Next, a method of decrypting the encrypted files with the security software and the USB flash memory disk will be described with reference to FIG. 7. As shown in FIG. 7, the method includes the following steps.

At step 401, the file to be decrypted is determined.

At step 402, whether the USB flash memory disk is properly connected or not is detected.

At step 403, whether the USB flash memory disk is properly connected or not is determined based on the detecting result in the step 402. If it is, the process goes to the step 406. If it is not, then the process goes to the step 404.

At step 404, the user is inquired whether to re-authenticate or not. If the user determines to re-authenticate, then the process goes to the step 405. Otherwise, the decryption process is exited. At that time, the file is still in the encrypted state.

At step 405, the user is prompted to connect the USB flash memory disk to the USB interface. The process returns to the step 402 after confirming the connection of the USB flash memory disk.

At step 406, the user inputs a decryption password.

At step 407, the authentication information of the USB flash memory disk is read.

At step 408, the password input by the user is authenticated according to the authentication information.

At step 409, whether the authentication is successful or not is determined. If it is successful, the process goes to the step 410. If it is not, the process returns to the step 404.

At step 410, the encrypted file is restore into the normal file.

It should be noted that the above embodiments are described for only illustrating the technical solutions of the present invention without limiting the scope of the present invention. Although the present invention is illustrated with reference to the preferred embodiments thereof, it should be understood by those skilled in the art that various changes or equivalent alterations to the present invention are possible without departing from the spirit or scope of the present invention and are encompassed in the scope defined by the claims of the present invention.

1. An authentication method based on private bytes of USB flash memory media, comprising:
step 10, reading authentication information from the private bytes of the USB flash memory media by an authentication unit;
step 20, authenticating, by the authentication unit, the authentication information input by a user by using the authentication information read from the private bytes of the USB flash memory media;
step 30, determining whether the authentication is successful or not, if it is successful, opening an operation authorization based on the authentication information, otherwise, executing a process for failed authentication.

2. The authentication method based on private bytes of USB flash memory media according to claim 1, wherein before the step 10, further comprising:
step 1, detecting whether the USB flash memory disk is connected to the authentication unit, if it is, executing the step 10;
step 2, inquiring the user whether to re-authenticate or not, if the user determines to re-authenticate, then prompting the user to connect a USB flash memory media to an USB interface, and executing the step 1 after confirming the connection, otherwise, determining that the authentication is failed, and executing the process for failed authentication.

3. The authentication method based on private bytes of USB flash memory media according to claim 2, wherein the process for failed authentication in the step 30 is to execute the step 2.

4. The authentication method based on private bytes of USB flash memory media according to claim 1, wherein before the step 10, further comprising:
step 1′, detecting, by the authentication unit, whether the USB flash memory disk is connected to the authentication unit or not;
step 2′, if the connection is held, executing the step 1′ after a predetermined time period, and if the connection is not held, then locking the operating system;
step 3′, prompting the user to connect the USB flash memory media to the USB interface and inputting the authentication information;
step 4′, detecting, by the authentication unit, whether the USB flash memory media is connected to the authentication unit;
step 5′, if the connection is held, then executing the step 10; otherwise, executing the step 3′.

5. The authentication method based on private bytes of USB flash memory media according to claim 4, wherein the process for failed authentication in the step 30 is to release the lock of the operating system and execute the step 1′ if it is successful, otherwise, execute the step 4′.

6. The authentication method based on private bytes of USB flash memory media according to claim 1, further comprising the step of setting the authentication information to the private bytes of the USB flash memory media when the authentication unit is installed, the setting step comprising:
step A, sending the authentication information input by the user to the private bytes of the USB flash memory media by the authentication unit;
step B, determining whether the operation of writing the authentication information into the private bytes of the USB flash memory media is successful, if it is successful, opening an operation authorization based on the authentication information, otherwise, executing a subsequent process for failed authentication if the operation of writing the authentication information is not successful.

7. The authentication method based on private bytes of USB flash memory media according to claim 6, wherein the operating system log-on information of the user is contained in the authentication information.

8. The authentication method based on private bytes of USB flash memory media according to claim 6 or 7, wherein before the step A, further comprising:
step X, detecting, by the authentication unit, whether the USB flash memory disk is connected with the authentication unit, if the connection is held, executing the step A;
step Y, inquiring the user whether to re-authenticate or not, if the user determines to re-authenticate, then prompting the user to connect the USB flash memory disk to the USB interface, and executing the step X after confirming the connection; otherwise, determining that the authentication is failed, and ending the setting process.

9. The authentication method based on private bytes of USB flash memory media according to claim 8, wherein the subsequent process for failed authentication in the step B is to execute the step Y.

10. The authentication method based on private bytes of USB flash memory media according to claim 1, wherein a control chip of the USB flash memory media receives a read/write instruction sent from the authentication unit, determines whether a read/write operation is executed to the private bytes, if it is, the read/write operation to the private bytes is executed, if it is not, the read/write operation to normal bytes is executed.

11. The authentication method based on private bytes of USB flash memory media according to claim 7, wherein before the step A, further comprising:
step X, detecting, by the authentication unit, whether the USB flash memory disk is connected with the authentication unit, if the connection is held, executing the step A;
step Y, inquiring the user whether to re-authenticate or not, if the user determines to re-authenticate, then prompting the user to connect the USB flash memory disk to the USB interface, and executing the step X after confirming the connection; otherwise, determining that the authentication is failed, and ending the setting process.
